(19) United States
(12) Patent Application Publication
(10) Pub. No.: US 2012/0281414 A1
(43) Pub. Date: Nov. 8, 2012

(54) DECORATIVE CHRISTMAS DISPLAY

(76) Inventor: Gary Scheffler, Egdar, WI (US)

(21) Appl. No.: 13/103,042

(22) Filed: May 7, 2011

(51) Int. Cl. F21V 33/00

(52) U.S. Cl. 362/253

(57) ABSTRACT

The present invention is a decorative Christmas display that includes a display box with a plurality of boards, a plurality of sheets of plywood, a top, a front and a roof attached to the top of the box. The front stench disposed on the front of display box depicts a nativity scene of baby Jesus and a light source to illuminate the front stencil displaying the nativity scene.

### TECHNICAL FIELD & BACKGROUND

Currently there are limited holiday nativity displays. Devoted Christians, who desire to decorate for Christmas or other celebrations, are always interested in novel ways to incorporate images of the baby Jesus and their redeemer's birth.

The present invention generally relates to a decorative display. More specifically, the invention is a decorative Christmas display.

It is an object of the invention to provide a decorative Christmas display that depicts a Nativity scene of baby Jesus.

It is an object of the invention to provide a decorative Christmas display that depicts a stencil of a Nativity scene of baby Jesus placed in front of a display box.

What is really needed is a decorative Christmas display that depicts a stencil of a Nativity scene of baby Jesus placed in front of a display box.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front perspective view of a decorative Christmas display, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

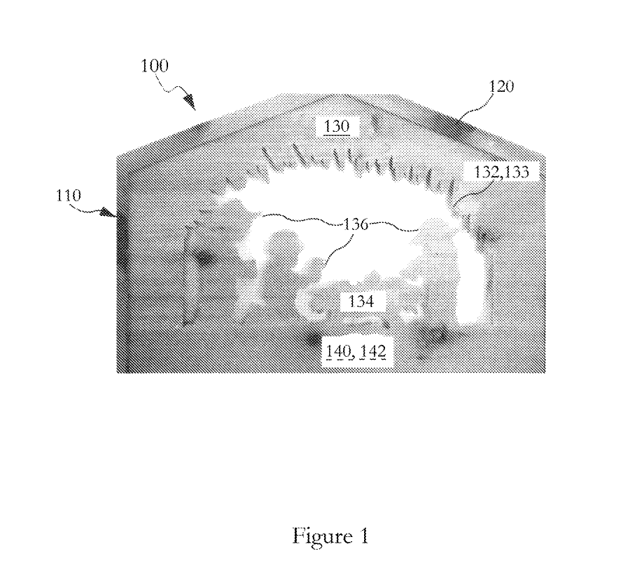

FIG. 1 illustrates a front perspective view of a decorative Christmas display 100, in accordance with one embodiment of the present invention. The decorative Christmas display 100 includes a display box 110, a roof 120, a front stencil 130 and a light source 140.

The display box 110 is made of cedar wood, but can be made of any other suitable material such as another type of wood or plastic. The roof 120 is attached to the top of the display box 110 and is also made of cedar wood, but can be made of any other suitable material such as another type of wood or plastic. The front stencil 130 is also made of cedar wood and depicts a scene 132 with a carriage 134 holding baby Jesus and three persons 136 standing near the carriage 134. The scene 132 specifically depicts a manger and a nativity scene 133 with the baby Jesus. The light source 140 is a light bulb 142 but can be any other suitable light source such as an LED light.

The decorative Christmas display illuminates the front stencil and functions as a festive decor accessory. The decorative Christmas display is made of cedar plywood and cedar board materials and is made of seven building components which creates a 24″ wide, 15″ high and 2¾″ deep display box for a nativity scene created by the front stencil. Powered by hardwire electricity or one or more batteries, the decorative Christmas display maintains a lighting silhouette by use of a 45 watt light bulb. The decorative Christmas display can come in various colors and sizes to accommodate diverse consumers. The three dimensional compartment house with light bulb and shadow illusionary benefits and affords Christian believers with an innovative way to display the holy birth story of Jesus Christ.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A decorative Christmas display, comprising:
a display box with a top and a front;
a roof attached to said top of box;
a front stencil disposed on said front of display box depicting a nativity scene of baby Jesus; and
a light source to illuminate said front stencil.

2. The display according to claim 1, wherein said display box is made of cedar wood.

3. The display according to claim 1, wherein said roof is made of cedar wood.

4. The display according to claim 1, wherein said stencil is made of cedar wood.

5. The display according to claim 1, wherein said light source is a light bulb.

6. The display according to claim 1, wherein said display is made of cedar wood.

7. A decorative Christmas display, comprising:
a display box with a plurality of boards, a plurality of sheets of plywood, a top and a front;
a roof attached to said top of box;
a front stencil disposed on said front of display box depicting a nativity scene of baby Jesus; and
a light source to illuminate said front stench.

8. The display according to claim 7, wherein said display box is formed from sad plywood, said boards, a plurality of nails and glue.

9. The display according to claim 7, wherein said roof is made of cedar wood.

10. The display according to claim 7, wherein said stencil is made of cedar wood.

11. The display according to claim 7, wherein said light source is a light bulb.

12. The display according to claim 7, wherein said display is made of cedar wood.

13. The display according to claim 7, wherein said light source is an LED light.

14. A decorative Christmas display, comprising:
a display box with a plurality of boards, a plurality of sheets of plywood, a top and a front;
a roof attached to said top of box;
a front stencil disposed on said front of display box depicting a nativity scene of baby Jesus; and
a light source to illuminate said front stench.

15. The display according to claim 14, wherein said display box is formed from sad plywood and sad boards being attached with a plurality of nails and glue.

16. The display according to claim 14, wherein said display box is attached to said roof with a plurality of tongue and groove fasteners.

17. The display according to claim 14, wherein said roof, said stencil and display are made of cedar wood.

18. The display according to claim 14, wherein said nativity scene includes said carriage holding baby Jesus and three persons standing near said carriage.

19. The display according to claim 14, wherein said light source is a light bulb.

20. The display according to claim 14, wherein said light source is an LED light.
